(19) United States
(12) Patent Application Publication
(10) Pub. No.: US 2017/0109190 A1
(43) Pub. Date: Apr. 20, 2017

(54) PROVIDING A CUSTOM VIRTUAL COMPUTING SYSTEM

(71) Applicant: Samuel Sha, Austin, TX (US)

(72) Inventor: Samuel Sha, Austin, TX (US)

(21) Appl. No.: 15/315,229

(22) PCT Filed: Jun. 1, 2015
(86) PCT No.: PCT/US15/33609

§ 371 Date: Nov. 30, 2016

Related U.S. Application Data
(60) Provisional application No. 62/005,776, filed on May 30, 2014.

(51) Int. Cl. G06F 9/455; G06F 9/445

(52) U.S. Cl. CPC G06F 9/45558; G06F 8/63; G06F 2009/4557; G06F 2009/45595; G06F 2009/45583

(57) ABSTRACT

Methods, systems, and apparatus, including computer programs encoded on a computer storage medium, for providing and managing custom virtual computing systems. In one aspect, a computer-implemented method includes receiving a request for one or more computing services, determining, based on the request, a virtual system image configured to provide a virtual computing system that provides the requested computing services, and deploying the virtual system image. The virtual computing system can be locked down for security.

### TECHNICAL BACKGROUND

This disclosure relates generally to virtual machines, more particularly, to providing, receiving, and managing custom virtual computing systems.

### BACKGROUND

A virtual appliance is a pre-configured virtual machine image, ready to run on a hypervisor. The virtual appliance can be created by installing a software appliance and/or an operating system (OS) on a virtual machine (VM) and packaging that into an image. Like software appliances, virtual appliances can eliminate the installation, configuration and maintenance costs associated with running complex stacks of software and/or OS.

### SUMMARY

The present disclosure relates to computer-implemented methods, software, and systems for providing and managing custom virtual computing systems. In one general embodiment, a computer-implemented method executed by one or more processors includes receiving a request for one or more computing services, determining, based on the request, a virtual system image configured to provide a virtual computing system that provides the requested computing services, and deploying the virtual system image.

In another general embodiment, a computer-implemented method executed by one or more processors includes transmitting a request for one or more computing services, the request including a description of a virtual system image configured to provide a virtual computing system, and receiving the virtual system image.

In another general embodiment, a computer-implemented method includes determining a virtual computing system that comprises one or more virtual appliances, the one or more virtual appliances providing one or more computing services; and locking down the virtual computing system.

Other general implementations include corresponding computer systems, apparatus, and computer programs recorded on one or more computer storage devices, each configured to perform the actions of the methods. A system of one or more computers can be configured to perform operations to perform the actions. One or more computer programs can be configured to perform particular operations or actions by virtue of including instructions that, when executed by data processing apparatus, cause the apparatus to perform the actions.

Aspects of the general embodiments include the following, each of which may be combined with one or more other aspects.

Determining a virtual system image includes: installing one or more virtual appliances into the virtual system image, the virtual appliances configured to provide the requested computing services.

The virtual appliances include: one or more first virtual appliances each configured to provide at least one of the requested computing services; and one or more second virtual appliances each configured to provide at least one support computing service.

The support computing service includes a network service, an authentication service, a management service, or an email service.

Each of the virtual appliances includes at least one of: application binary, operating system (OS) binary, device drivers, or metadata.

Each of the virtual appliances includes configuration data.

The virtual system image includes a portion including configuration data associate with each of the virtual appliances.

Deploying the virtual system image includes deploying the virtual system image onto one or more physical hardware.

The virtual system image includes a hypervisor, and deploying the virtual system image includes installing the hypervisor on the physical hardware.

Deploying the virtual system image includes deploying the virtual appliances to a hypervisor on the physical hardware.

The hypervisor is configured to manage execution of the virtual appliances, allocate hardware resources of the physical hardware, create virtual hardware for the virtual appliances, or enable data communication between the virtual appliances and the hardware resources.

Locking down at least one of the virtual appliances or the hypervisor.

Said locking down includes configuring at least one of the virtual appliances and the hypervisor to be read-only.

Said locking down includes encrypting at least one of the virtual appliances, the hypervisor, or configuration data associated with the hypervisor.

Said locking down includes obscuring at least one of the virtual appliances, the hypervisor, or configuration data associated with the hypervisor.

Said locking down includes disabling user login to at least one of the virtual appliances or the hypervisor.

Said locking down includes storing the virtual appliances and the hypervisor in a first portion of the physical hardware that is read-only.

Said locking down includes sealing the virtual appliances and the hypervisor in the first portion of the physical hardware by trusted platform module (TPM).

Said locking down includes sealing the virtual appliances and the hypervisor in the first portion of the physical hardware by a physical key.

Said locking down includes storing first data associated with each of the virtual appliances in the first portion of the physical hardware, and the first data includes at least one of: application binary, operating system (OS) binary, or configuration data.

Storing second data associated with each of the virtual appliances logically or physically separate from the first data, and the second data includes at least one of: application data, run time variables, or user data.

The second data is stored in a second portion of the physical hardware that is readable and writable.

Providing the deployed physical hardware to a client associated with the request.

Said providing includes providing one or more computing devices together with the deployed physical hardware to the client.

Said providing includes providing an instruction to the client, the instruction indicating the client to connect the physical hardware to one or more computing devices.

The virtual computing system provides a private cloud that includes a private network for a plurality of computing systems.

The private network provides at least one of an authentication function or an authorization function for each computing system of the plurality of computing systems or a user associated with the computing system.

The private cloud includes at least one of a firewall or a proxy configured to restrict communications between remote computing systems outside of the private network and the plurality of computing systems.

The private cloud includes a multi-tier network that includes multiple firewalls or proxies for the multi-tier network.

The private cloud is configured to connect to one or more public cloud servers to provide a hybrid cloud, such that a user associated with one of the computing systems in the private cloud is able to access one or more server services provided by the one or more public cloud servers through the configured connection.

Deploying the virtual system image includes deploying the virtual system image onto one or more cloud servers.

Said deploying includes deploying the virtual appliances in the virtual system image to a hypervisor on the cloud servers.

Locking down at least one of the virtual appliances or configuration data associated with the hypervisor.

Said locking down includes at least one of: configuring at least one of the virtual appliances or the configuration data associated with the hypervisor to be read-only; encrypting at least one of the virtual appliances or the configuration data associated with the hypervisor; or disabling user login to the hypervisor.

The virtual computing system provides a virtual private cloud on the cloud servers.

The virtual private cloud is configured to connect to one or more public cloud servers to provide a hybrid cloud, such that a user is able to access one or more server services provided by the one or more public cloud servers through the configured connection.

Deploying the virtual system image includes deploying one or more first virtual appliances of the virtual appliances onto one or more physical hardware and one or more second virtual appliances of the virtual appliances onto one or more cloud servers.

The first virtual appliances are configured to provide a first private cloud and the second virtual appliances are configured to provide a second private cloud, and the first private cloud is connected to the second private cloud via virtual private network (VPN).

At least one of the first private cloud or the second private cloud is configured to connect to one or more public cloud servers to create a hybrid cloud, such that a user is able to access one or more server services provided by the one or more public cloud servers through the configured connection.

Locking down the virtual system image.

Said locking down includes at least one of: configuring the virtual system image to be read-only; encrypting the virtual system image; obscuring the virtual system image or disabling user login to at least part of the virtual system image.

Receiving a second request for updating or adding a particular computing service; and providing, based on the second request, one or more particular virtual appliances configured to provide the particular computing service and to be locked down.

Receiving a second request for updating the virtual computing system;
determining, based on the second request, a second virtual system image that is configured to provide the updated virtual computing system; and deploying the second virtual system image to implement the updated virtual computing system.

The second request includes usage data downloaded from the virtual computing system.

Said receiving includes receiving the second request offline without connection to the virtual computing system.

Receiving a second request includes receiving the second request online with connection to the virtual computing system.

Receiving a request includes receiving the request through one or more of an email, a phone call, a mail, an online request, or by physically taking an order by a sales representative.

The requested computing services include at least one of an email server service, a database server service, an exchange server service, a network service, a directory and authentication service, or an accounting system service.

The requested computing services include one or more services for providing software applications, customized games, or personalized DVDs/CDs.

Presenting a graphical user interface (GUI) to a user associated with the request, the GUI including a plurality of input fields each defining one or more specifications for virtual computing systems.

The specifications include at least one of computing services, deployment options, security options, network options, performance options, or price options associated with the performance options.

Receiving an input for one or more of the plurality of input fields from the user, and determining a system profile based on the input.

Determining at least of configurations for one or more virtual appliances or a configuration for a hypervisor associated with the virtual appliances.

Particular embodiments of the subject matter described in this specification can be implemented to realize one or more advantages. Providing a custom virtual computing system enables a computing device with a secure on-premise plug-and-play private cloud in a box, containing all needed IT infrastructure, business applications, which provides true Service as a Service (SaaS) cloud experience without special client side applications. Providing such a custom virtual computing system can achieve better utilization for a physical computing system, lower hardware cost, better space utilization, and lower power consumption, to users and organizations that do not have technical manpower to administer installation, set-up and configuration of hardware and software needed in virtual machine networks. Costs needed to support an information technology (IT) department in a user organization can be reduced or eliminated, as all systems and network administration tasks can be done when the custom virtual computing system is built and subsequent user-requested adjustment or re-purposing can be done through service call or remote web application. The custom virtual computing system can be provided and/or managed on a service computing system. The service computing system can include an ordering system, a service hosting system such as Infrastructure as a service (IaaS), or a combination thereof. The service computing system can be accessed through web graphical user interface (GUI) by any device with a browser such as Internet Explorer (IE), Google Chrome, or Firefox. Managing a custom virtual computing system on the service computing system can enable ease of remotely making changes to existing virtual computing system configurations in a user organization and with minimal disruption to the user organization. The service computing system can provide the user organization virtual appliance images or virtual system images associated with the changes.

The custom virtual computing system can be locked down and sealed in the physical hardware, e.g., at a hypervisor level or a virtual appliance level. User data can be logically or physically separated from the hypervisor and virtual appliances. The custom virtual computing system can provide an entire private cloud in user-owned and controlled hardware. The private cloud can include a private network requiring authentication and authorized sign on to access internally and with an ability to block access from outside the user organization if desired. The private network can be a multi-tier network infrastructure for insuring user data security and privacy. For example, the private cloud can provide multiple firewalls and/or proxies configured to restrict communications between remote computing systems outside of the private network and the plurality of computing systems. The private network can operate offline within the user organization's internal network and independent from public network. A user of the user organization can use both server services provided by the custom virtual computing system in the private network and server services hosted in the service hosting computing and/or public cloud servers. Technologies including locking down to virtual appliances or virtual system image can be used to provide protection for server services and avoid hacker attack. The packing and bundling process can be applied in PC, media, gaming industry, or the like. Users can use the process to create their own customized PC with pre-packaged software bundles, personalized DVDs/CDs, or customized game packages.

These general and specific aspects may be implemented using a device, system, method, or any combinations of devices, systems, or methods. The details of one or more implementations are set forth in the accompanying drawings and the description below. Other features, objects, and advantages will be apparent from the description and drawings, and from the claims.

### DESCRIPTION OF DRAWINGS

FIG. 1A depicts an example system for providing and managing a custom virtual computing system.

FIG. 1B depicts an example custom virtual computing system.

FIG. 2 depicts an example system for managing a custom virtual computing system.

FIG. 3A depicts an example process for providing a custom virtual computing system.

FIG. 3B depicts an example process for managing a custom virtual computing system.

FIG. 3C depicts another example process for managing a custom virtual computing system.

FIG. 4A depicts an example virtual appliance architecture.

FIG. 4B depicts another example virtual appliance architecture.

FIG. 5A depicts an example system architecture for a virtual computing system.

FIG. 5B depicts another example system architecture for a virtual computing system.

### DETAILED DESCRIPTION

The present disclosure describes systems, apparatus, and methods for providing and managing custom virtual computing systems. In some implementations, a system receives a request for one or more computing services, e.g., from a system administrator of an entity. Based on the request, the system can generate a virtual system image configured to provide a virtual computing system that provides the requested computing services. The virtual computing system can be considered as a custom virtual computing system. For example, the system can determine virtual appliances providing the requested computing services and deploy the virtual appliance into the virtual system image. The system can also add additional virtual appliances providing support computing services into the virtual system image. The virtual appliances can coordinate to provide a cohesive private cloud. For security, the virtual system image can be locked down, e.g., by being configured to be read-only, encrypted, obscured, and/or disabled for user login at a hypervisor level or at a virtual appliance level.

The system can deploy the virtual system image to implement the virtual computing system. In some examples, the system deploys the virtual system image on one or more physical hardware. After deployment, the system can lock down the virtual computing system including the virtual appliances and a hypervisor configured to manage execution of the virtual appliances. The system can disable all aspects of system administration, e.g., no user login at the hypervisor level or the virtual appliance level, and/or encrypt or obscure the virtual appliances and the hypervisor. The system can also configure the virtual appliances and the hypervisor to be read-only. The hypervisor and the virtual appliances can be locked down, e.g., by trusted platform module (TPM) and/or a physical key, and stored in a read-only portion of the physical hardware. User data and application data or run time variables can be stored logically or physically separately from the read-only portion. The system can provide the physical hardware deployed with the virtual system image to the user. The virtual computing system can provide a secure private cloud for a user organization within the user-owned and controlled physical hardware. If the user wants to change or update the virtual computing system, the user can send a request to the system online or offline, and the system can provide new locked down virtual appliances or virtual system images to the user.

In some examples, the system deploys the virtual system image on one or more cloud servers such as Infrastructure as a service (IaaS) (e.g., public cloud servers and/or a service hosting system in the system), where the virtual computing system provides a virtual private cloud. In some examples, the system deploys part of the virtual system image, e.g., one or more virtual appliances, to one or more physical hardware to provide a private cloud and another part of the virtual system image, e.g., another one or more virtual appliances, to one or more cloud servers to provide a virtual private cloud. The private cloud on the physical hardware and the virtual private cloud on the cloud servers can communicate through virtual private networks (VPNs) to provide a hybrid cloud. A user can use a computing device in the private cloud to access one or more computing services provided by the virtual private cloud in the cloud servers through the VPN. In some implementations, the private cloud on the physical hardware and/or the virtual private cloud on the cloud servers can be configured to connect to one or more public cloud servers to create a hybrid cloud. The public cloud servers can be software as a service (SaaS) cloud servers that provide one or more server services like Gmail service. A user can use a computing device in the private cloud to access the server services on the public cloud servers via the configured connection, or the user can access the server services on the public cloud servers through the virtual private cloud.

In some implementations, a system provides security protection for one or more computing services, e.g., server services like accounting services. The system can determine a virtual computing system including virtual appliances that provide the computing services to be protected. The system can configure lock down the virtual computing system including the virtual appliances and a hypervisor configured to manage execution of the virtual appliances. The system can encrypt and/or obscure the virtual appliances, the hypervisor, and/or configuration data associated with the hypervisor, disabling user login to the virtual appliance and the hypervisor, and/or configured the virtual appliances and the hypervisor to be read-only. In some examples, if the virtual computing system is deployed on physical hardware, the system can lock down, e.g., by TPM and/or a physical key, the hypervisor and the virtual appliances in a read-only portion of the physical hardware. Application data, run time variables, or user data can be stored logically or physically separate from the hypervisor and the virtual appliances, e.g., in a readable and writable portion of the physical hardware.

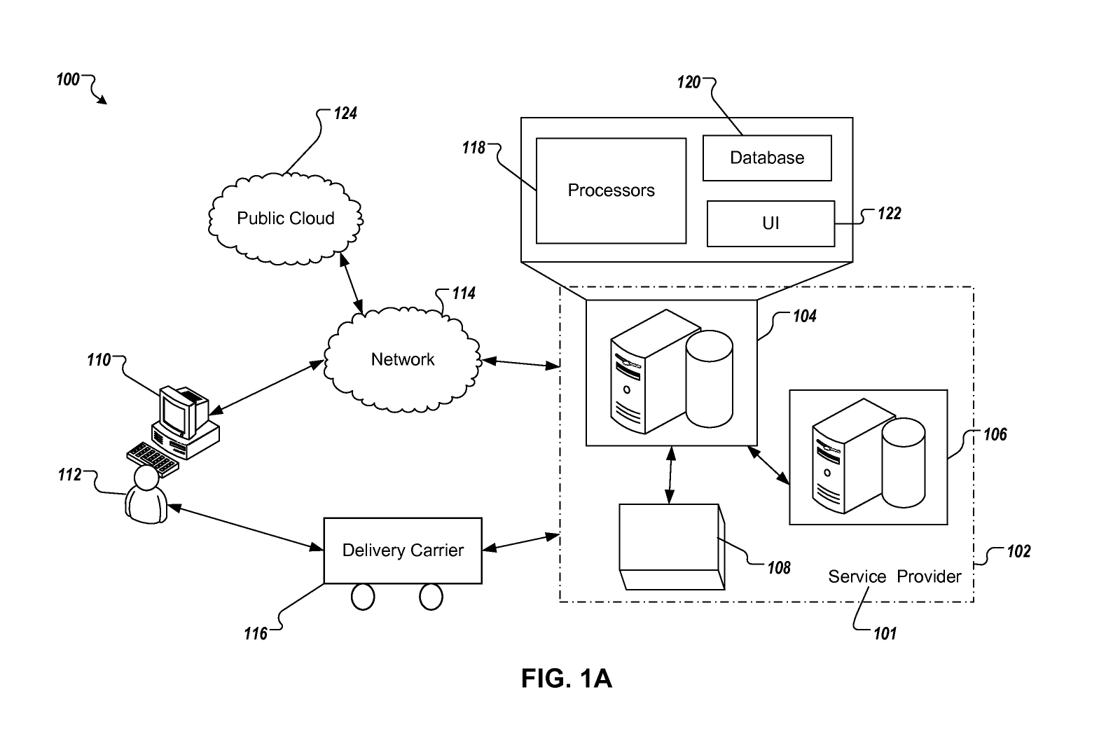

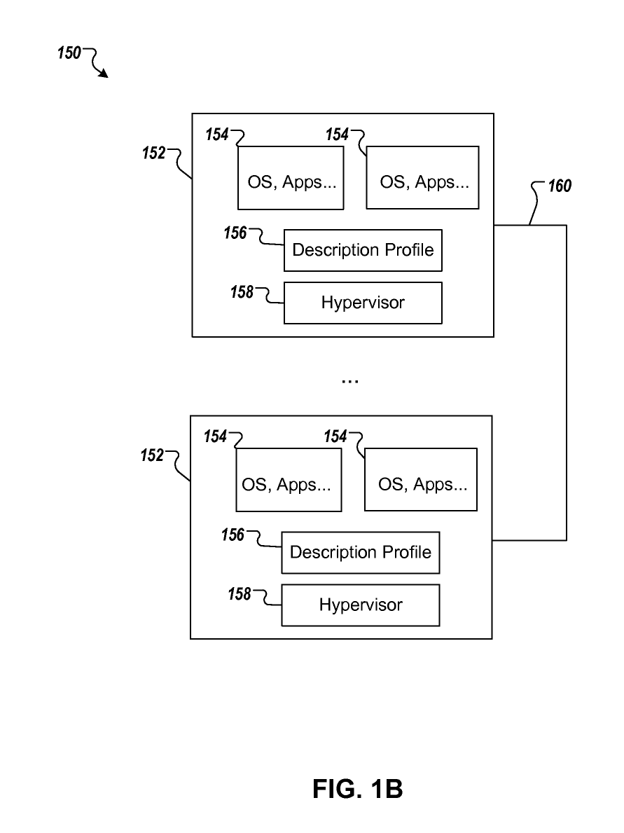

FIG. 1A illustrates an example system 100 for providing and managing custom virtual computing systems. The example system 100 includes a service computing system 102 associated with a service provider 101, a user-side computing device 110 associated with a user 112, and a network 114, e.g., a data communication network. The system 100 can also include one or more public cloud servers 124. The user-side computing device 100, the service computing system 102, and the public cloud servers 124 can communicate with one another over the network 114.

The network 114 can include a large computer network, such as a local area network (LAN), a wide area network (WAN), the Internet, a cellular network, or a combination thereof connecting any number of mobile computing devices, fixed computing devices and ordering systems. The user-side computing device 110 can include any appropriate type of device such as a personal computer, a handheld computer, a notebook, a tablet computing device, a personal digital assistant (PDA), a smart mobile phone, an enhanced general packet radio service (EGPRS) mobile phone, a media player, a navigation device, an email device, a text message device, a game console, or any appropriate combination of any two or more of these data processing devices or other data processing devices. The service computing system 102 can include one or more computing devices and one or more machine-readable repositories, or databases.

As discussed above and below, the service computing system 102 can include an ordering system 104, a service hosting system 106, a hardware facility 108, or a combination thereof. The ordering system 104 allows users to place or update orders for custom virtual computing systems that provide the computing services the users requested. The service computing system 102, e.g., the ordering system 104, can provide virtual appliances to provide the computing services.

The computing services can include an email server service, a database server service, an exchange server service, a network service, an accounting system service, a directory and authentication service, a payroll service, or any other common services. In some examples, the computing services include collaboration suite including email, spam filter calendar and briefcase file repository, Dropbox-like File Sharing Server, various enterprise resource planning (ERP) servers, software source code control system, and/or support ticket tracking System. In some examples, the computing services include one or more server services provided by public cloud servers such as software as a service (SaaS) servers like Gmail servers.

In some implementations, the service computing system 102 includes the service hosting system 106. The service hosting system 106 is configured to host virtual appliances to provide server services. The service hosting system 106 can be an Infrastructure as a service (IaaS). In some other implementations, the service computing system 102 does not include the service hosting system 106. The service hosting system 106 can be a cloud server associated with a separate entity other than the service provider 101. For example, the service hosting system 106 can be one of the public cloud servers 124, including Amazon Web Services (AWS), Windows Azure, Google Compute Engine, Rackspace Open Cloud, or IBM SmartCloud Enterprise.

The ordering system 104 allows users to order one or more computing services. In some implementations, the ordering system 104 includes one or more processors 118, a database 120, and a user-interface (UI) module 122. The database 120 can store a plurality of software applications, and/or a plurality of operating systems (OSs). In some examples, the database includes virtual appliance packages, virtual appliance images, and/or virtual appliance runtime snapshots. The virtual appliance packages can include virtual hardware and/or software packages. In some examples, the database 120 stores a plurality of system profiles. Each system profile can specify a virtual computing system that provides one or more computing services. In some cases, the system profile includes metadata describing requirements of the virtual computing system, reference to instructions on how to install operating systems and required software packages, and a configuration file section containing configuration content for the virtual computing system. The metadata can include deployment or distribution information, a kickstart file, a listing of operating systems, versions and types of software applications, virtualization needs, e.g., amount of random access memory, amount of persistent storage, and/or capabilities of central processing units (CPUs), types of configuration management systems being used, and/or configuration management classes. In some examples, the system profile includes security keys and certifications for configuration data associated with hypervisors and/or virtual appliances.

The processors 118 are coupled to the database 120 and can create, deploy, configure, and/or manage virtual computing systems. The processors 118 can create a virtual system image configured to provide a custom virtual computing system based on requested computing services. For example, the processors 118 can determine a virtual appliance (e.g., an image or a package or a runtime snapshot of the virtual appliance) that provides one or more computing services and deploy the virtual appliance into the virtual system image. In some examples, as noted above, the computing services include one or more server services provided by public cloud servers such as software as a service (SaaS) servers. The processors 118 can add one or more connections into the customized system profile and/or the virtual system image. As described above and below, the added connections can enable the custom virtual computing system to connect to the public cloud servers during run time to create a hybrid cloud.

The ordering system 104 can deploy the created virtual system image on one or more physical hardware. The ordering system 104 can provision the physical hardware from bare metal based on the system profile. Each provisioned physical hardware can include an installed hypervisor that supports and manages virtual appliances on the physical hardware. The hypervisor can allocate hardware resources of the physical hardware, create virtual hardware for the virtual appliances, or enable data communication between the virtual appliances and the hardware resources. In the present specification, a hypervisor can be a type 1 hypervisor, a type 2 hypervisor, a hybrid hypervisor such as Kernel-based Virtual Machine (KVM), or any appropriate type of hypervisor. The hypervisor can be also referred to a host operating system (OS).

The user 112 can use the user-side computing device 110 to access the ordering system 104 through the UI module 120 via the network 114. The UI module 120 can include a graphical user interface (GUI), e.g., a Web-based user interface. In some cases, the GUI provides a menu driven screen that can direct the user 112 to create a customized profile for a desired virtual machine or virtual computing system. The user 112 can manually create a profile using a command line interface or by email or by paper mail. In some cases, the user 112 provides information including a size of the user organization, a size of customers/clients/products, and/or required services. In some examples, the GUI includes a plurality of input fields. Each input field defines one or more specifications to determine virtual computing systems. The specifications can include computing services, deployment options, security options, network options, and/or price/performance options. The user 112 can provide an input for one or more input fields to specify computing services. The ordering system 104 can then determine a system profile based on the specified computing services and/or provided information. The system profile specifies desired virtual appliances or virtual computing system customized by the user 112.

The ordering system 104 can also add additional support computing services in addition to the user selected or requested computing services. The support computing services can be associated with virtual routers and switches, firewalls, proxies, VPN, database server services, virtual network-attached storage (NAS), virtual storage area network (SAN), authentication server service, email service, customer relationship management (CRM), enterprise resource planning (ERP), project management, and/or any other appropriate computing services. The additional support computing services can be provided by virtual appliance packages/images/snapshots. The ordering system 104 can also determine configuration data for each virtual appliance and configuration data for a hypervisor associated with the virtual appliances. In some cases, when the virtual system image is deployed on physical hardware, virtual network-attached storage (NAS) and virtual storage area network (SAN), as well as routers, switches, and/or printers, etc., can be deployed on the physical hardware.

In some implementations, the ordering system 104 provides a plurality of system profiles based on the requested/selected computing services. Each system profile can provide a respective virtual computing system for providing the requested/selected computing services. The ordering system 104 can provide the system profiles together with associated performance and prices for each of the system profiles. The user 112 can input to choose a specific system profile from the plurality of system profiles, and the ordering system 104 then determines the specific system profile to be the target system profile for specifying a custom virtual computing system.

The user 112 can register a user account with the ordering system 104. The user account can be associated with one or more system profiles customized for the user 112 in a database, e.g., the database 120, of the ordering system 104. The user 112 can log on the ordering system 104 to access the user account and to monitor, maintain, or manage the customized system profiles stored in the database. The ordering system 104 can store a customer profile associated with the user account. The customer profile can include the user account, the user input, and/or the one or more system profiles. The customer profile can be provided in the custom virtual computing system. As discussed in details below, the user 112 can access, e.g., via the GUI, the customer profile on the ordering system 104 and manage the customer profile, e.g., to update, change, or add one or more computing services in the custom virtual computing system. Based on the request, the ordering system 104 can provide the user 112 one or more virtual appliances and/or a new virtual system image. The virtual appliances and/or the new virtual system image can be locked down, e.g., to be read-only.

In some implementations, the ordering system 104 determines a system profile specifying a custom virtual computing system. The ordering system 104 can generate or determine a virtual system image based on the system profile. The virtual system image includes one or more virtual appliances (packages/images/runtime snapshots) that provide the computing services specified in the system profile. The virtual system image is configured to provide the custom virtual computing system. In some implementations, the ordering system 104 directly determines the virtual system image based on the user's input or request. The ordering system 104 can also lock down the virtual system image. For example, the ordering system 104 can configure at least part of the virtual system image to be read-only, encrypted, obscured, and/or disabled to user login. For example, the virtual system image can be disabled to user login at a hypervisor level or a virtual appliance level, while access can be enabled at an application level in the virtual system image.

The ordering system 104 can deploy the virtual system image on one or more physical hardware. In some implementations, the service computing system 102 includes the hardware facility 108, e.g., a hardware supply store or a hardware assembly line, for providing a variety of computing hardware, e.g., hard disk drive (HDD), memory, processor, other computer hardware, and network hardware. Each physical hardware can be a physical implementation of a computing platform or a storage device, e.g., a personal computer, a laptop, a wireless device, a workstation, a server, or a HDD. The service computing system 102 can choose suitable hardware, e.g., physical computers or HDDs, from the hardware facility 108, to deploy the virtual system image to implement the custom virtual computing system.

In some implementations, the virtual system image includes a hypervisor. When deploying the virtual system image on the physical hardware, the service computing system 102 can install the hypervisor on the physical hardware, such that the hypervisor can allocate hardware resources of the physical hardware, create virtual hardware for the virtual appliances, or enable data communication between the virtual appliances and the hardware resources. In some implementations, as noted above, the service computing system 102 can provision the physical hardware by installing a hypervisor on the physical hardware, e.g., based on a system profile. When the virtual system image is deployed onto the physical hardware, the hypervisor can access to the virtual appliances in the virtual system image and manage execution of the virtual appliances, e.g., by allocating hardware resources of the physical hardware, creating virtual hardware for the virtual appliances, or enabling data communication between the virtual appliances and the hardware resources. The deployed virtual system image on the physical hardware can provide the custom virtual computing system.

In some implementations, after deployment, the service computing system 102, e.g., the ordering system 104, locks down the custom virtual computing system including the virtual appliances and the hypervisor. The service computing system 102 can disable all aspects of system administration, e.g., no user login at the hypervisor level or the virtual appliance level. In some cases, in case of service, the service computing system 102 can keep a restricted account to login the virtual computing system. The service computing system 102 can also encrypt and/or obscured the virtual appliances and/or the hypervisor and/or configuration data associated with the hypervisor. In some examples, the service computing system 102 configures the virtual appliances and the hypervisor to be read-only. The hypervisor and the virtual appliances can be stored in a read-only portion of the physical hardware and locked down, e.g., by trusted platform module (TPM) and/or a physical key. Application binary, operating system (OS) binary, or configuration data of the virtual appliances can be stored in the read-only portion. Addition data associated with the virtual appliances including application data or run time variables and user data can be stored logically or physically separate from the data stored in the read-only portion. The additional data can be stored in a readable and writable storage, e.g., a separate portion of the physical hardware. In some cases, user data are encrypted and/or obscured. The user data can be protected by disabling root/admin login, firewalls/proxies, programs' integrity, and/or ultimately users themselves. The custom virtual computing system on the physical hardware can run in non-persistent mode, like a live CD software appliance.

The service provider 101 can provide the deployed physical hardware to the user 112. The service provider 101 can also provide one or more computing devices to the user 112. The computing devices can be connected to the deployed physical hardware and configured to operate the custom virtual computing system. The user 112 can directly use the custom virtual computing system without further configuration, e.g., in a user organization. In some implementations, the service provider 101 provides an instruction to the user 112. The instruction guides the user to connect the deployed physical hardware to one or more computing devices, e.g., by plugging in. The computing devices can then make the physical hardware function, e.g., automatically, to provide the custom virtual computing system.

In some implementations, the service provider 101 directly delivers the physical hardware deployed with the virtual computing system to the user through the delivery carrier 116, e.g., a shipping carrier. The delivery carrier 116 provides services including one or more of overnight delivery service, same-day delivery service, one-day delivery service, two-day delivery service, three-day delivery service, tracking service, and picking up service. The delivery carrier 116 includes the United States Postal Service (USPS), UPS, FedEx, DHL, or any appropriate carrier.

In some implementations, the hardware facility 108 is associated with one or more entities other than the service provider 101. The one or more entities can be an original equipment manufacturer (OEM) or an original design manufacturer (ODM) or a combination of them, or any other manufacturers. The one or more entities can be associated with the service provider 101 or have cooperation relationship with the service provider 101. In some implementations, the service provider 101 provides the virtual system image corresponding to the custom virtual computing system to the entities. The entities can deploy the virtual system image on the physical hardware to implement the custom virtual computing system. The entities can directly deliver the deployed physical hardware to the user 112, or deliver the deployed physical hardware to the service provider 101 who delivers it to the user 112. In some implementations, the service provider 101 provides information including a system profile corresponding to a custom virtual computing system and/or instructions and/or associated programs to one or more entities. The entities can prepare a virtual system image based on the received information and deploy the virtual system image on physical hardware to implement the custom virtual computing system. In some implementations, the service provider 101 provides specifications associated with the custom virtual computing system or required physical hardware to the entities. The entities can prepare the physical hardware based on the specifications and send back to the service provider 101. Then the service provider 101 can deploy the virtual system image on the physical hardware.

In some implementations, the service computing system 102 deploys a virtual system image on one or more cloud servers including the service hosting system 106, the public cloud servers 124, or a combination of them. The cloud servers can include a hypervisor. The virtual system image can be deployed to the cloud servers. The hypervisor can access the virtual system image and manage to execute virtual appliances in the virtual system image. The hypervisor can allocate hardware resources of the cloud servers, create virtual hardware for the virtual appliances, or enable data communication between the virtual appliances and the hardware resources. After deployment, the service computing system 102 can lock down the virtual appliances and configuration data associated with the hypervisor, e.g., by executing instructions or programs on the cloud servers. The virtual appliances and configuration data associated with the hypervisor can be configured to be read-only, encrypted, obscured, or disabled for user login to the virtual appliances and the configuration data. The virtual appliances are coordinated to provide a virtual private cloud on the cloud servers and managed to provide the computing services. A user can access the virtual private cloud, e.g., by the network 114 and/or with security authorization and/or by virtual private network (VPN), to use the computing devices. For example, a VPN client on a computing device of the user can be used to authorize with a VPN server on the virtual private cloud to establish a secure VPN tunnel for data communication. In some implementations, the virtual private cloud on the cloud servers is configured to connect to one or more public cloud servers to create a hybrid cloud. The public cloud servers can be software as a service (SaaS) cloud servers that provide one or more server services like Gmail service. A user can use a computing device, e.g., in the network 114, to access the server services on the public cloud servers through the configured connection as well the network 114 and/or the virtual private cloud.

In some implementations, the service computing system 102 deploys a virtual system image partially on one or more physical hardware and partially on one or more cloud servers. For example, the service computing system 102 can deploys one or more virtual appliances on the physical hardware and another one or more virtual appliances to the cloud servers. The virtual appliances on the physical hardware can coordinate to provide a private cloud, and the virtual appliances on the cloud servers can coordinate to provide a virtual private cloud. The private cloud on the physical hardware and the virtual private cloud on the cloud servers can be configured to communicate through virtual private networks (VPNs) to create a hybrid cloud. A user can use a computing device in the private cloud to access one or more computing services provided by the virtual private cloud in the cloud servers through the VPN. In some implementations, the private cloud on the physical hardware and/or the virtual private cloud on the cloud servers can be configured to connect to one or more public cloud servers to create a hybrid cloud. The public cloud servers can be software as a service (SaaS) cloud servers that provide one or more server services like Gmail service. A user can use a computing device in the private cloud to access the server services on the public cloud servers via the configured connection, or the user can access the server services on the public cloud servers through the virtual private cloud.

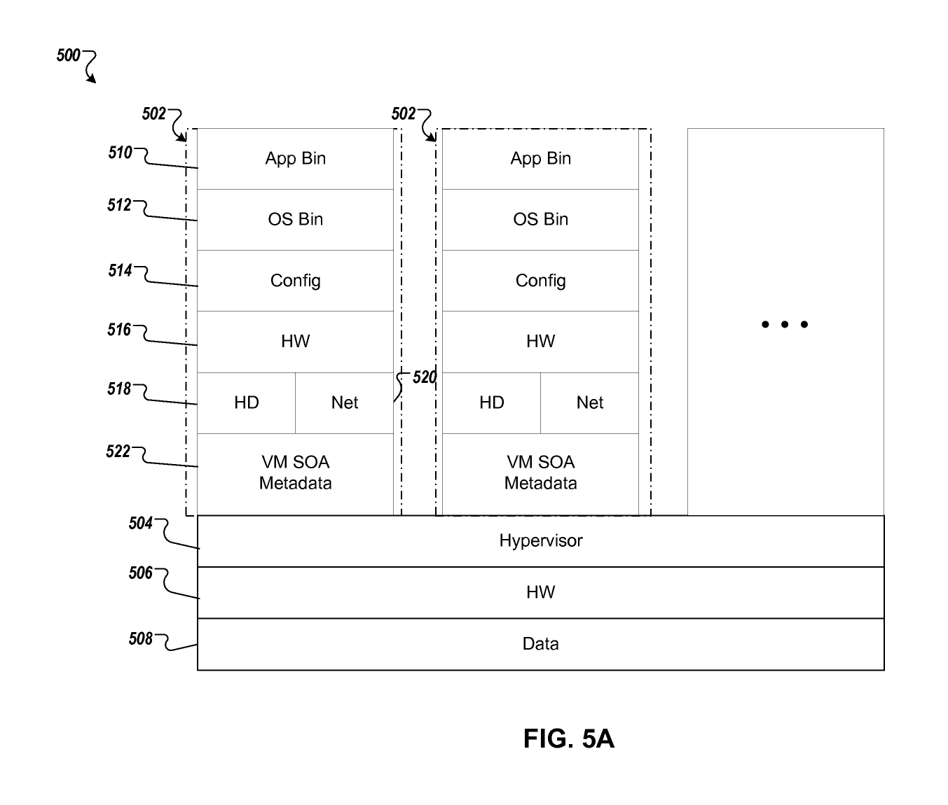

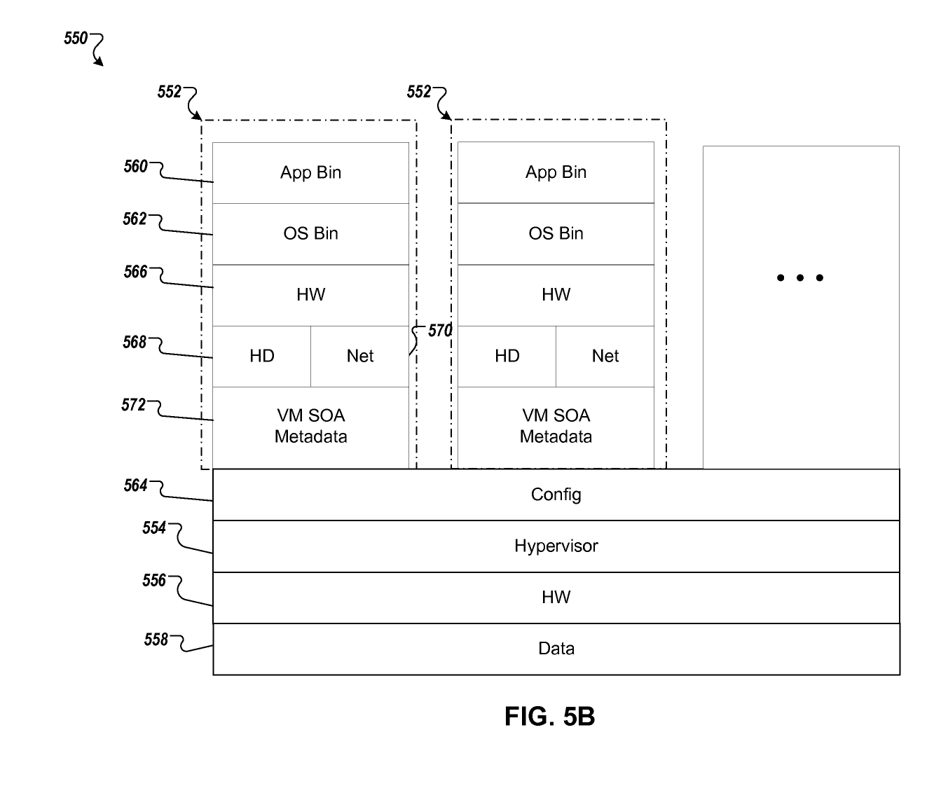

FIG. 1B illustrates an example virtual computing system 150 that includes one or more physical hardware 152 and one or more virtual appliances 154 (or virtual machines/virtual servers) deployed on each physical hardware 152. The physical hardware 152 can communicate with each other through an internal network 160. In some implementations, each individual physical hardware 152 includes a description profile 156 that describes information associated with the physical hardware 152. The description profile 156 can include configuration data associated with a hypervisor. Communications between the physical hardware 152 and/or virtual appliances may be achieved by using the description profiles 156. As described in further details in FIG. 5B, configuration data associated with each virtual appliance can be stored outside of the virtual appliance and in a portion of the physical hardware. During boot time, the configuration data can be accessed by the virtual appliances. Each virtual appliance 154 can provide one or more virtual server services. Each virtual appliance 154 has its own guest operating system (OS), e.g., Windows, Unix, Linux, or Netware, and one or more software applications (Apps). The guest operating systems of the virtual appliances 154 may be the same or different from each other.

In some implementations, each physical hardware 152 includes a hypervisor 158. The hypervisor 158 may be a piece of computer software, firmware, hardware, or a combination thereof. The hypervisor 158 runs directly on the physical hardware 152 to control hardware resources of the physical hardware 152 and to manage execution of virtual appliances 154 on the physical hardware 152. In some cases, the hypervisor 158 allocates the hardware resources and/or enables data communication between the virtual appliances and hardware resources in the physical hardware and/or the hardware resources communicatively connected to the physical hardware. The hypervisor 158 can operate as a second software layer and enables virtualization of hardware resources in the physical hardware and/or virtualization of hardware resources communicatively connected to the physical hardware. Guest operating systems of virtual appliances run at a third level above the hardware resources. In some cases, a virtual appliance directly controls one or more hardware resources on the physical hardware 152.

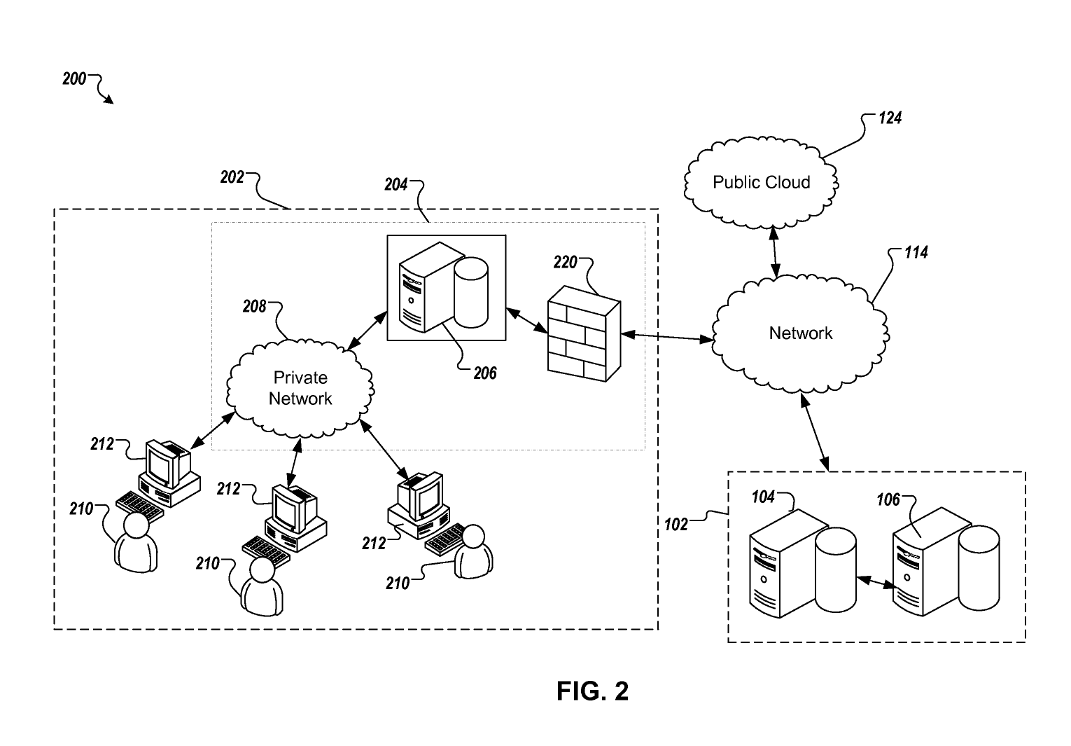

FIG. 2 depicts an example system 200 for managing, e.g., using, a custom virtual computing system 204 in a user organization 202. The custom virtual computing system 204 can be the virtual computing system 150 in FIG. 1B. A user, e.g., the user 112 of FIG. 1A, can order computing services, e.g., server services, from a service provider, e.g., the service provider 101 of FIG. 1A. The service provider can be associated with a service computing system, e.g., the service computing system 102 of FIG. 1A. Based on the user's order, the service computing system can generate a virtual system image and deploy the virtual system image to provide the custom virtual computing system 204, e.g., on one or more physical hardware 206. The physical hardware 206 can be similar to the physical hardware 152 of FIG. 1B.

The custom virtual computing system provides a private cloud. For example, virtual appliances in the custom virtual computing system 204 can coordinate to provide a cohesive private cloud. The private cloud includes a private network 208. The private network 208 can run on the physical hardware 206 in the user organization 202. The private network 208 can operate offline within the user organization's internal network and independent from public network, e.g., the network 114 of FIG. 1A. The private network 208 provides a network service for a plurality of internal computing devices 212, e.g., remotely or local to the physical hardware 206. The internal computing device 212 can be the user-side computing device 110 of FIG. 1A.

The private network 208 can include network infrastructure, e.g., a complete enterprise strength network infrastructure including router, bridges, subnets, virtual private network (VPN), firewalls/proxies and/or centralized authentication system. The private network 208 can include an authentication and authorization function, e.g., a central authentication and authorization function, that enables a user to securely sign on to access one or more computing services through Web GUI with a secure single sign on (SSO) capability. An internal user 210 can be authenticated and authorized appropriate access to use the server services provided by the custom virtual computing system 204 via the private network 208. The internal user 210 may communicate with other internal users 210 within the private network 208.

In some implementations, the service computing system 102 deploys one or more additional virtual appliances onto one or more cloud servers including the service hosting system 106 and/or the public cloud servers 124. The virtual appliances on the cloud servers are coordinated to provide a virtual private cloud and managed to provide additional computing services. The private cloud on the physical hardware 206 in the user organization 202 can be configured to connect to the virtual private cloud on the cloud servers through virtual private network (VPN). An internal user 210 in the user organization 202 can access the virtual private cloud to use the computing devices on the virtual private cloud through the VPN.

In some implementations, the private network 208 in the custom virtual computing system 204 includes a firewall/proxy 220. The firewall/proxy 220 can be a virtual appliance in the custom virtual computing system 204. The firewall/proxy 220 is configured to restrict communications between remote computing systems, e.g., the service computing system 102, outside of the private network 208 and the custom virtual computing system 204 and thus the plurality of internal computing devices 212. The firewall/proxy 220 can block all communication channels from outside the user organization 202 if desired. The firewall/proxy 220 allows a communication channel between the custom virtual computing system 204 and the service computing system via the network 114. The communication channel may be encrypted by secure shell (SSH) protocol, secure sockets layer (SSL) or transport layer security (TLS). A user can communicate with the service computing system 102 through the communication channel via the firewall/proxy 220 and the network 114.

In some implementations, the private cloud includes a multi-tier network for insuring user data security and privacy. The multi-tier network can include multiple firewalls and/or proxies. The firewalls and/or proxies can be configured to restrict communications between remote computing systems outside of the multi-tier network and the plurality of computing systems. The multiple firewalls and/or proxies can be deployed in series or configured as a hybrid multi-firewall. The firewalls and/or proxies can also restrict traffic within the private network to create different security zones where virtual servers are placed. In some cases, the private network operates online and communicates to public network through the firewalls and/or proxies. In some cases, the private network operates offline within a user organization's internal network and independent from public network.

In some implementations, as noted above, the private cloud is configured to connect to one or more public cloud servers to create a hybrid cloud. The public cloud servers can be software as a service (SaaS) cloud servers that provide one or more server services like Gmail service. The internal user 210 can use the computing device 212 in the private cloud to access and use the server services on the public cloud servers via the configured connection as well as the private network 208 and/or the firewall/proxy 220.

As noted above, a user can register a user account on the service computing system 102, e.g., the ordering system 104 of FIG. 1A. The user account may be associated with a customer profile in a database, e.g., the database 120 of FIG. 1A. The custom profile includes a customized system profile stored on the physical hardware 206. The user can log on the ordering system 104 to access the user account and manage the customized system profile.

In some implementations, the service computing system 102, e.g., the ordering system 104, provides a remote management function. The user can send a request for managing the customized system profile so that the user can request to change or update the custom virtual computing system on the physical hardware 206 remotely in the user organization 202. The service computing system 102 may first authenticate a user account for the user to determine whether the user is authenticated and authorized to access the database. After determining that the user is authenticated and authorized to access the database, the service computing system 102 further identifies the customer profile or the customized system profile associated with the user account.

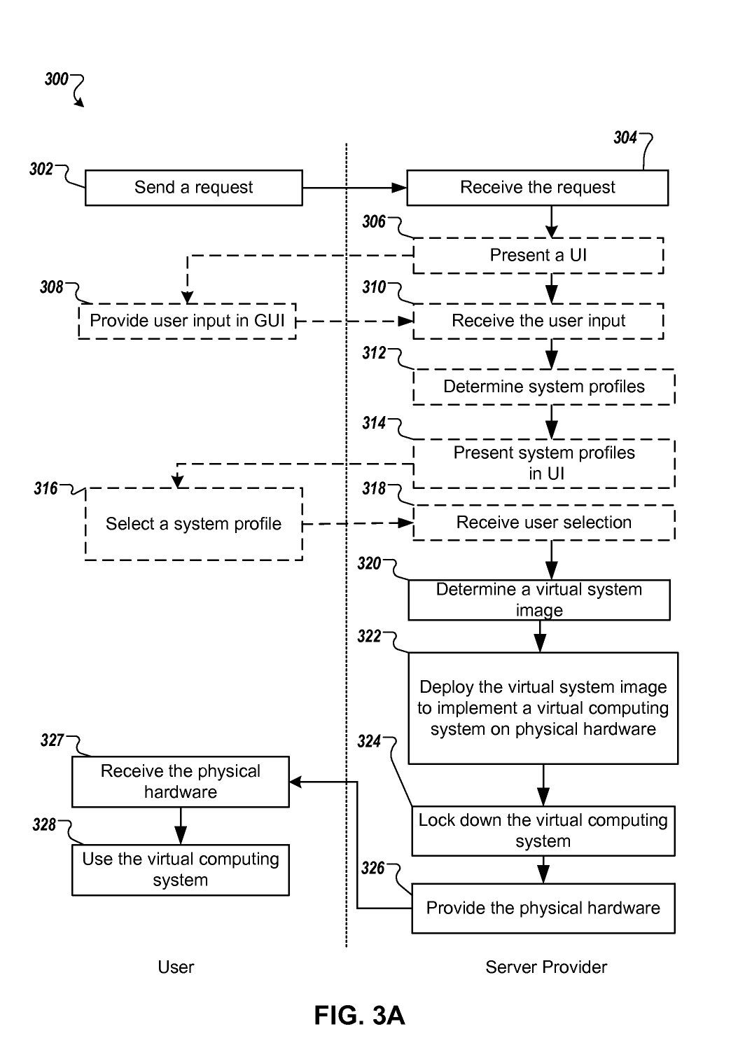

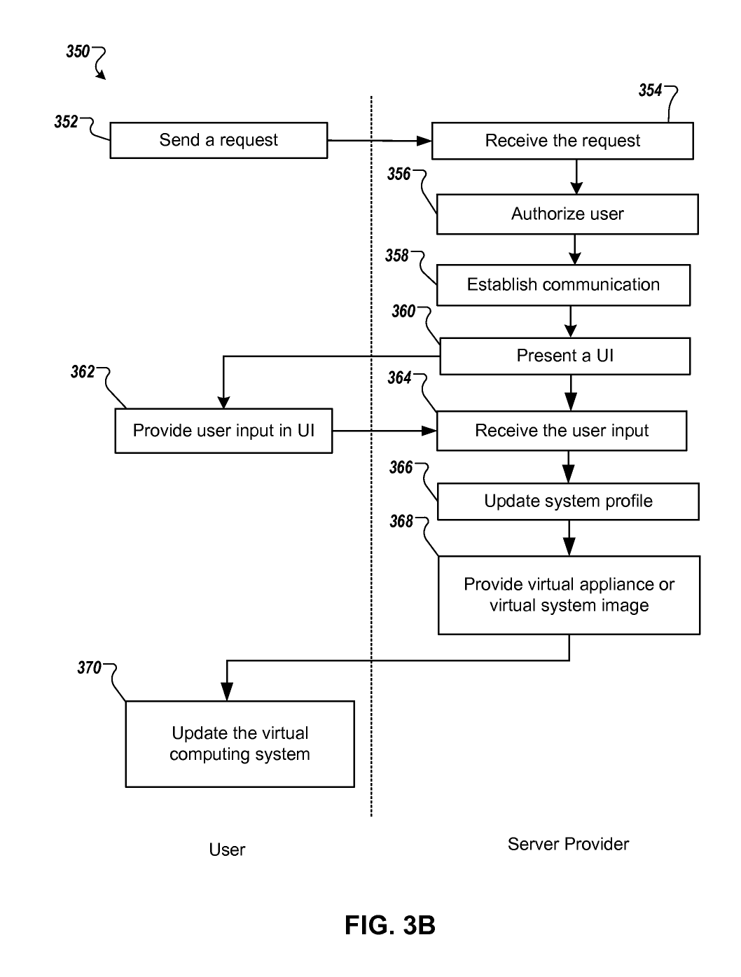

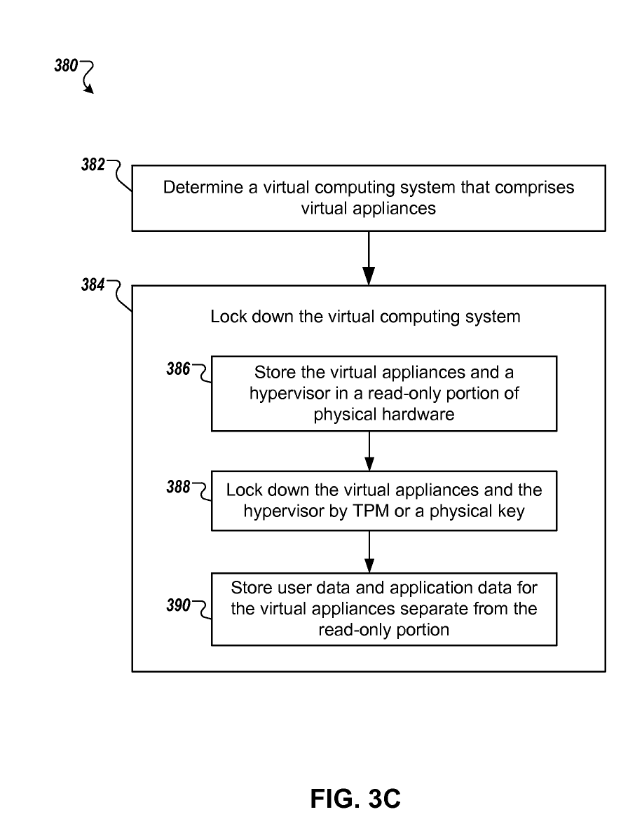

As discussed in further details in FIG. 3B below, the user can add or change one or more server services to the customized system profile. For example, the user can select the one or more server services from a list provided in a user interface, e.g., the UI 122 of FIG. 1A. In some cases, the service computing system 102 determines that one or more updates for the one or more service services in the customized system profile exist. The service computing system can prompt the user to select the updates. When the service computing system 102 determines that the one or more server services have been added to the customized system profile, the service computing system 102 can determine one or more virtual appliance (in the format of images/packages/runtime snapshots) corresponding to the one or more server services. The virtual appliances can be locked down, e.g., configured to be read-only. In some cases, the service provider stores the virtual appliances onto a storage device and provides the storage device to the user. The user can just copy the virtual appliances onto the physical hardware 206. A hypervisor on the physical hardware 206 can be configured to detect the virtual appliances and manage execution of the virtual appliances. In some cases, the service provider transmits the virtual appliances to the user, e.g., through the network 114. In some cases, the service computing system 102 determines a new virtual system image based on the user's request or selection, deploys the new virtual system image on one or more physical hardware, and provides the deployed physical hardware to the user to replace the physical hardware 206 in the user's organization 202.

In some examples, the user may delete one or more server services from the customized system profile. When the service computing system 102 determines that the one or more server services has been deleted from the system profile, the service computing system 102 can transmit an instruction or command or any other suitable executable forms to the custom virtual computing system 204 to uninstall or disable or turn off the one or more server services on the physical servers 206.

In some cases, the service computing system 102 extends capability of the custom virtual computing system 204 on the physical hardware 206 by providing the user access server services on cloud servers, e.g., the service hosting system 106 and/or the public servers 124. The service computing system 102 can archive or migrate virtual appliances on the physical hardware 206. The service computing system 102 may allow the user to select to migrate one or more server services to the cloud servers. As noted above, the user can access the migrated server services on the cloud servers through the private network 208 and the firewall/proxy 220 and/or through virtual private network (VPN). In some cases, the user sends the physical hardware 206 back to the service provider for reconfiguration or reinstallation.

FIG. 3A depicts an example process for a service provider providing a custom virtual computing system to a user. The service provider can be the service provider 101 of FIG. 1A. The service provider can be associated with a service computing system, e.g., the service computing system 102 of FIG. 1A. The service computing system can include an ordering system, e.g., the ordering system 104 of FIG. 1A, and/or a service hosting system, e.g., the service hosting system 106 of FIG. 1A. The user can be the user 112 of FIG. 1A or the user 210 of FIG. 2.

The user sends a request (302). The user may request one or more server services or a virtual computing system providing the one or more server services. The request can include information about a size of the user organization, a size of products, a size of customers/clients, and/or required services. The user can send the request from a user-side computing device, e.g., the user-side computing device 112 of FIG. 1A, to the service computing system through a network, e.g., the network 114 of FIG. 1A. The user can send the request via an email or through a web-based user-interface of the service computing system, e.g., the UI module 122 of FIG. 1A. In some cases, the user sends the request by a mail or a phone call to the service provider. In some cases, the user meets a sales representative associated with the service provider and submits the request to the sales representative.

The service provider receives the request (304). The service provider can receive the request with the ordering system in the service computing system. The service provider can determine one or more system profiles (312) based on the request. Each system profile specifies a custom virtual computing system that can provide the one or more server services in the request.

In some implementations, the service computing system presents a user interface (UI) (306). The service computing system can present the UI based on the request. The UI may be a web-based GUI including a plurality of input fields. Each input field defines one or more specifications for virtual appliances or virtual computing systems. For example, the specifications include types of server services, versions and types of software applications, and/or virtualization needs, e.g., amount of random access memory, amount of persistent storage, and/or capabilities of central processing units (CPUs). The user provides user input for one or more input fields in the UI (308). The user can select the one or more specifications from a menu list or manually input the specifications for the virtual computing system. The service computing system receives the user input (310) and determines one or more system profiles (312) based on the received user input and/or the request. In some examples, the service computing system directly determines one or more system profiles based on the user's request without user input.

In some implementations, the service computing system presents the determined system profiles in the UI (314). In some cases, each system profile is presented together with associated system performance and price in the UI. The user can select a system profile from the presented system profiles in the UI (316). The user may select the system profile based on one or more factors, e.g., a budget. The service computing system can receive the user selection (318) to determine the selected system profile to be a target system profile for the custom virtual computing system. The service computing system can include a customer profile associated with the user. The customer profile can include the user input and the selected system profile.

The service computing system determines a virtual system image (320) based on the selected system profile or the request. In some examples, the service computing system determines virtual appliances providing the requested computing services and deploy the virtual appliances into the virtual system image. The service computing system can also add additional support computing services in addition to the user selected or requested computing services. The additional support computing services can be provided by virtual appliance packages or images in the virtual system image. The virtual appliances in the virtual system image can coordinate to provide a secure and cohesive private cloud. As noted above, the virtual system image can be locked down for security, e.g., by being configured to be read-only, encrypted and/or obscured.

In some implementations, the service computing system prepares one or more physical hardware based on the selected system profile. The system profile may include requirements for the physical hardware, e.g., amount of random access memory, amount of persistent storage, and/or capabilities of central processing units (CPUs). The service computing system can prepare the physical hardware from a hardware facility, e.g., the hardware facility 110 of FIG. 1A, or from external entities such as OEM or ODM. In some cases, the service computing system provides a plurality of different configurations for the physical hardware based on the system profile. Each configuration can be presented in the UI together with associated performance and price. The user can select a specific configuration from the plurality of different configurations. The service computing system can prepare one or more physical hardware based on the specific configuration.

The service computing system deploys the virtual system image on the physical hardware to implement a custom virtual computing system (322). The service computing system can provision the physical hardware from bare metal. A hypervisor can be installed on the physical hardware, e.g., based on the system profile, and configured to manage the virtual appliances in the virtual system image. The implemented custom virtual computing system can be ready for use.

The service computing system locks down the virtual computing system (324). After deployment, the service computing system can lock down the virtual computing system in a number of ways, as discussed above. For example, the service computing system can disable all aspects of system administration, e.g., no user login at the hypervisor level or the virtual appliance level. The service computing system can also encrypt and/or obscure the virtual appliances, the hypervisor, and/or configuration data associated with the hypervisor. In some examples, the service computing system configures the virtual appliances and the hypervisor to be read-only. The hypervisor and the virtual appliances can be stored in a read-only portion of the physical hardware and locked down, e.g., by trusted platform module (TPM) and/or a physical key. Application binary, operating system (OS) binary, or configuration data of the virtual appliances can be stored in the read-only portion. Addition data associated with the virtual appliances including application data or run time variables and user data can be stored logically or physically separate from the data stored in the read-only portion. The additional data can be stored in a readable and writable storage, e.g., a separate portion of the physical hardware.

The service computing system provides the deployed physical hardware to the user (326). The service computing system can deliver the deployed physical hardware to the user through a delivery carrier, e.g., the delivery carrier 114 of FIG. 1A. The user receives the physical hardware (326), and uses the custom virtual computing system (328) in a user organization. In some examples, the user can directly use the physical hardware. In some examples, the service computing system provides instructions to the user. The instructions can guide the user to connect the physical hardware to one or more computing devices to run the custom virtual computing system. The custom virtual computing system can provide a secure private cloud for a plurality of internal computing devices, e.g., the computing devices 212 of FIG. 2 within the user organization.

As noted above, in some implementations, the service computing system can deploy the virtual system image on one or more cloud servers such as Infrastructure as a service (IaaS) including a public cloud server, e.g., the public cloud server 124 of FIG. 1A, and/or a service hosting system, e.g., the service hosting system 106 of FIG. 1. In some implementations, the service computing system deploys part of the virtual system image, e.g., one or more virtual appliances, to one or more physical hardware to provide a private cloud and another part of the virtual system image, e.g., another one or more virtual appliances, to one or more cloud servers to provide a virtual private cloud. The private cloud on the physical hardware and the virtual private cloud on the cloud servers can communicate through virtual private networks (VPNs) to create a hybrid cloud. A user can use a computing device in the private cloud to access one or more computing services provided by the virtual private cloud in the cloud servers through the VPN.

FIG. 3B depicts an example process for managing a custom virtual computing system. The service computing system may provide a remote management function and the user can access the service computing system to manage the customized system profile on the service computing system or send a request to the service computing system.

The user sends a request (352). For example, when a size of a user organization changes, the user may want to expand or narrow capability of the custom virtual computing system. The request may include a reference for the custom virtual computing system, e.g., a customer profile identification or a customized system profile identification, and/or related information, e.g., resource usage and/or current usage data. The usage data can be collected at the hypervisor level, like the disk usage, system or network performance, etc. The user may use any suitable computing device to send the request. The user may send the request to the service computing system through a secured communication channel. As noted above, the firewall/proxy can allow a communication channel between the custom virtual computing system and the service computing system via a network. The user can also send the request offline without connection to the network, e.g., by mail, phone calls, or meeting with a sales/support representative associated with the service provider.

The service computing system receives the request (354). After receiving the request, the service computing system may authenticate and authorize the user (356). The user may register a user account with the service computing system, e.g., when the user purchases the custom virtual computing system from the service provider. The user account can be associated with a customer profile in a database, and the customer profile can include a customized system profile that corresponds to a custom virtual computing system. The service computing system can authenticate the user account and associated credentials to authenticate and authorize the user. After determining that the user is authenticated and authorized to access the database, the service computing system can further identify or determine the customer profile associated with the user account.

The service computing system establishes a communication session (358) between the service computing system and the custom virtual computing system. The service computing system presents a UI to the user (360). The UI may be customized for the user account. The UI may present current settings in the system profile, e.g., operating systems, software applications, and/or server services.

The user provides user input in the UI (362). The user may choose to add or upgrade one or more server services into the system profile specifying the custom virtual computing system. The user may choose to delete one or more server services from the system profile for the custom virtual computing system. In some cases, the user may choose to update the operating systems and/or the software applications on the custom virtual computing system. The user may require additional server services provided by public cloud servers, e.g., software as a service (SaaS) cloud servers. In this case, the service computing system may add one or more connections into the customized system profile. The added connections enable the custom virtual computing system to connect to the public cloud servers during run time.

The service computing system receives the user input (364) and updates the system profile (366) for the user. As noted above, the service computing system can determine the user input and take corresponding actions. The service computing system can determine one or more virtual appliances (e.g., virtual appliance images/packages/runtime snapshots) or a new virtual system image and provide the virtual appliances or the new virtual system image to the user (368). The service computing system can provide the virtual appliances or the virtual system image by transmitting online, e.g., through VPN. The service computing system can also deploy the virtual appliances or the new virtual image on physical hardware that can be delivered to the user.

After receiving the virtual appliances or the new virtual system image, the user can update the custom virtual computing system (370). If the service provider provides physical hardware deployed with the new virtual system image, the user can directly replace the previous physical hardware with the deployed physical hardware to use the updated custom virtual computing system. In some case, reconfiguration can be executed on the physical hardware, e.g., automatically. During reconfiguration, the physical hardware may be offline, e.g., from the user organization's internal computing systems or internal networks. After reconfiguration, the physical hardware may reboot. In some cases, the reconfiguration occurs while the custom virtual computing system is running on the physical hardware. In some implementations, the user meets a sales or support representative associated with the service provider. The sales or support representative can help the user configure the custom virtual computing system on the physical hardware per the user's request.

FIG. 3C depicts an example process 380 for managing a virtual computing system. The virtual computing system comprises one or more virtual appliances that provide one or more computing services, e.g., server services like accounting services. A service computing system can provide secure protection the computing services. The service computing system can be the service computing system 102 of FIG. 1A.

The system determines a virtual computing system that includes virtual appliances (382). The virtual appliances provide one or more computing services to be protected. The system locks down the virtual computing system (384). The system can lock down the virtual computing system by configuring the virtual appliances to be read-only, encrypting the virtual appliances, obscuring the virtual appliances, and/or disabling user login to the virtual appliances.

In some implementations, the system determines that virtual computing system deployed in one or more physical hardware. A hypervisor on the physical hardware is configured to manage execution of the virtual appliances. The system can lock down the virtual appliances and the hypervisor, e.g., by encrypting and/or obscuring the virtual appliances, the hypervisor, and/or configuration data associated with the hypervisor, and/or disabling user login to the virtual appliances and the hypervisor. The system can also configure the virtual appliances and the hypervisor to be read-only.

In some implementations, the system stores the virtual appliances and a hypervisor in a read-only portion of the physical hardware (386). Application binary, operating system (OS) binary, and/or configuration data of the virtual appliances can be stored in the read-only portion. The system locks down the virtual appliances and the hypervisor in the read-only portion by trusted platform module (TPM) or a physical key (388). Any other appropriated ways can be used as well. The system stores user data and application data or run time variables separate from the read-only portion (390). For example, the user data and application data or run time variables can be stored in a readable and writable portion of the physical hardware.

In some implementations, the system determines that the virtual computing system is deployed on one or more cloud servers and that a hypervisor on the cloud servers is configured to manage execution of the virtual appliances. The system can lock down the virtual computing system by locking down the virtual appliances and configuration data associated with the hypervisor, e.g., by configuring the virtual appliances and the hypervisor configuration data to be read-only, encrypting and/or obscuring the virtual appliances and the hypervisor configuration data, and/or disabling user login to the virtual appliances and the hypervisor configuration data.

In some implementations, the system configures the virtual appliances or the virtual computing system to provide a private cloud. The private cloud can include a private network configured to provide an authentication and authorization function for each of a plurality of computing systems or a user associated with the computing system. The private network can be a single-tire network or a multi-tier network. The private cloud can also include one or more firewalls or proxies configured to restrict communications between remote computing systems outside of the private network and a plurality of computing systems.

In some implementations, the system determines that one or more first virtual appliances of the virtual appliances deployed on one or more physical hardware and one or more second virtual appliances of the virtual appliances deployed onto one or more cloud servers. The system can configure the first virtual appliances on the physical hardware to provide a first private cloud and the second virtual appliances on the cloud servers to provide a second private cloud. The system can establish a connection between the first private cloud and the second private cloud via virtual private network (VPN).

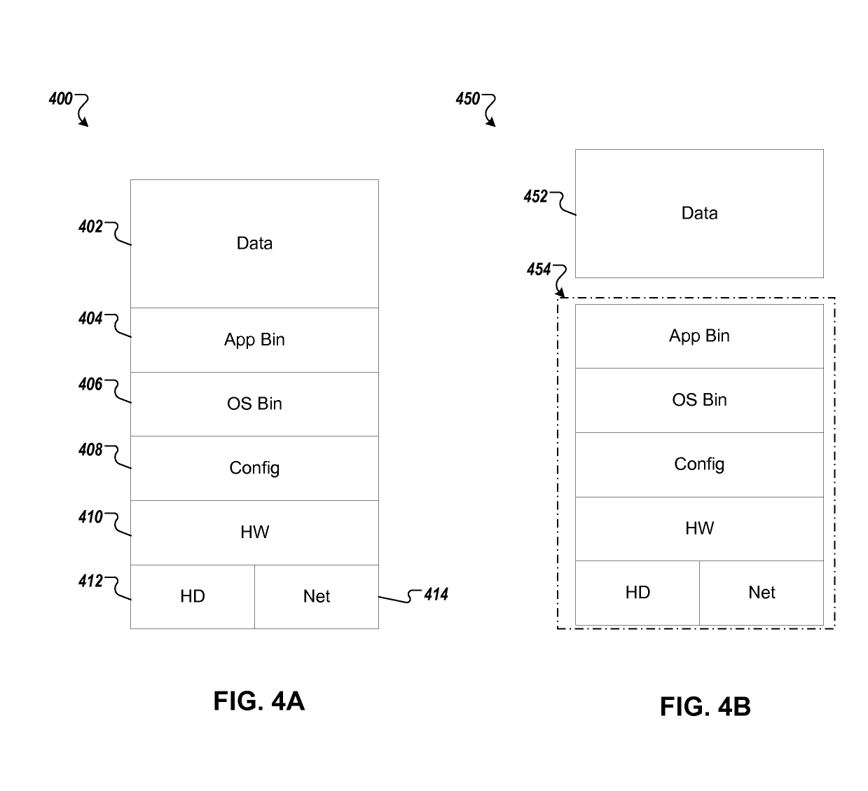

FIG. 4A depicts an example architecture of a system 400. The system 400 can be configured to provide one or more computing services, and can include software and/or hardware configurations or components. In some implementations, the architecture of the system 400 includes application data and/or run time variables 402, application binary (bin) 404, operating system (OS) binary 406, OS configuration and/or persistent data 408, virtual hardware 410, and/or plug in hardware components such as hard disk (HD) 412 and/or network card (Net) 414.

When the system 400 is realized in physical hardware, components may change or remain unchanged. For example, application binary 404 and OS binary 406 remain unchanged unless updates on application binary 404 and/or OS binary 406 happen. OS configuration 408 remains unchanged or changes less frequently unless the system 400 is repositioned, repurposed or reconfigured. Virtual hardware 410 and plugin hardware components such as hard disk 412 and network card 414 remain the same unless hardware fresh occurs, which may cause a major migration. Application data and/or run time variables 402 can change frequently, e.g., all the time, during run time.

FIG. 4B depicts another example architecture of a system 450. The system 450 can include components similar to the components of the system 400 of FIG. 4A. As discussed above, during run time, application data and/or run time variables 452 changes frequently, while other components 454 of the system 450, including application binary, OS binary, OS configuration, hardware, plugin hardware components such as hard disk and network card, remain unchanged or change less frequently. In some implementations, the components 454 are virtualized as a virtual appliance and deployed in a portion of physical hardware, and application data and/or run time variables 452 is stored separately from the virtual appliance, e.g., in a second, different portion of the physical hardware, thus application data and/or run time variables 452 is logically or physically separated from the other components 454 of the system 450.

As noted above, the virtual appliance can be locked down to prevent alteration, unauthorized access, e.g., by hackers, and/or virus infection (thereby requiring no anti-virus scan). In some cases, if the OS and/or applications need updates, the entire virtual appliance can be replaced with a new virtual appliance that provides the updated OS and/or applications. In some cases, reconfiguration, re-purposing and reposition of the system 450 can also be achieved by replacing the virtual appliance with one or more new virtual appliances.

FIG. 5A depicts an example architecture of a system 500 for providing a virtual computing system. The virtual computing system can be the virtual computing system 150 in FIG. 1B, providing a plurality of computing services. The virtual computing system can include one or more virtual appliances 502. Each virtual appliance 502 can be the virtual appliance 154 of FIG. 1B and configured to provide one or more computing services of the plurality of computing services. The virtual computing system can be implemented on physical hardware 506. The physical hardware 506 can include a hypervisor 504, e.g., the hypervisor 158 of FIG. 1B. The hypervisor 504 can manage execution of the one or more virtual appliances 502 on the physical hardware 506.

In some implementations, each virtual appliance 502 has a system architecture similar to the system 450 of FIG. 4B. The virtual appliance 502 can include application binary 510, OS binary 512, virtual hardware 516, and/or plugin hardware components such as hard disk 518 and network card 520. In some implementations, as illustrated in FIG. 5A, each virtual appliance 502 include OS configuration data 514. In some implementations, as illustrated in a system architecture 550 of FIG. 5B, the OS configuration data 564 of each virtual appliance 552 is stored separately from the application binary 560, the OS binary 562, the virtual hardware 566, and the hard disk 568 and network card 570 in the virtual appliance 552, and stored together in a portion of the physical hardware 556. During boot time, the configuration data can be accessed by the virtual appliances 552. As described in further details below, application data and/or user data 558 associated with the virtual computing system, e.g., one or more applications running on the virtual appliances 552, can be stored in another different portion of the physical hardware 556, which can be readable and writeable.

In some cases, each virtual appliance 502 includes metadata 522 for the virtual appliance 502. The metadata 522 can describe what the virtual machine does, e.g., what computing service the virtual appliance 502 provides, and how to utilize its computing service. The metadata 522 can also include what services or resources are required by the virtual appliance 502. Thus, with the metadata 522, the virtual appliance 502 can provide a service oriented architecture (SOA) IT environment. As noted above, to increase security, the virtual appliance 502 can be locked down.

The hypervisor 504 is configured to manage execution of the virtual appliances 502 on the physical hardware 506, create virtual hardware for the virtual appliances 502, allocate hardware resources of the physical hardware 506, and enable data communication between the virtual appliances 502 and the hardware resources. The virtual appliances 502 can be built with static configuration information, e.g., embedded in initial configuration parameters in a configuration file, or through mounted virtual file system or Kernel parameters at boot.

As noted above, the virtual computing system 500 including the virtual appliances 502 and the hypervisor 504, can be stored in a read-only portion of the physical hardware 506. The portion of the physical hardware 506 can be locked down and sealed, e.g., by trusted platform module (TPM) and/or a physical key. Application data and/or user data 508 associated with the virtual computing system, e.g., one or more applications running on the virtual appliances 502, can be stored in another different portion of the physical hardware, which can be readable and writeable. Application data and/or user data 508 can be accessed by authorized users, e.g., through and being restricted by applications running on the virtual appliances 502, while the virtual appliances 502 and the hypervisor 504 cannot be accessed by the users. In some implementations, the physical hardware 506 is partitioned into different portions or zones according to usage, such as a portion for the sealed virtual appliances 502 and hypervisor 504, a portion for application data and/or user data 508, and/or a portion for configuration metadata, logs, and/or cache, which allows easy sealing of the virtual appliances 502 and hypervisor 504 and easy implementations of user data backup.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described.

Nevertheless, it will be understood that various modifications may be made without departing from the spirit and scope of the present disclosure. Accordingly, other implementations are within the scope of the following claims.

1-181. (canceled)

182. A computer-implemented method, comprising:
receiving a request for one or more computing services;
determining, based on the request, a virtual system image configured to provide a virtual computing system that provides the requested computing services;
deploying the virtual system image; and
locking down the virtual computing system.

183. The computer-implemented method of claim 182, wherein said deploying the virtual system image comprises deploying the virtual system image onto at least one of:
one or more physical hardware,
one or more cloud servers, or
one or more hybrid cloud servers including one or more private cloud servers and one or more public cloud servers.

184. The computer-implemented method of claim 182, wherein said determining a virtual system image comprises:
installing one or more virtual appliances into the virtual system image, the virtual appliances configured to provide the requested computing services.

185. The computer-implemented method of claim 184, wherein said deploying the virtual system image comprises:
installing a hypervisor on a physical hardware; and
deploying the virtual appliances to the hypervisor on the physical hardware.

186. The computer-implemented method of claim 185, wherein said locking down the virtual computing system comprises:
locking down at least one of the virtual appliances or the hypervisor.

187. The computer-implemented method of claim 186, wherein said locking down the virtual computing system comprises at least one of:
configuring at least one of the virtual appliances or the hypervisor to be read-only,
encrypting at least one of the virtual appliances, the hypervisor, or configuration data associated with at least one of the virtual appliances or the hypervisor,
obscuring at least one of the virtual appliances, the hypervisor, or configuration data associated with at least one of the virtual appliances or the hypervisor, or
disabling user login to at least one of the virtual appliances or the hypervisor.

188. The computer-implemented method of claim 186, wherein said locking down the virtual computing system comprises:
storing the virtual appliances and the hypervisor in a first portion of the physical hardware.

189. The computer-implemented method of claim 188, wherein said locking down the virtual computing system comprises at least one of:
configuring the first portion of the physical hardware to be read-only,
encrypting contents of the first portion of the physical hardware,
obscuring contents of the first portion of the physical hardware,
sealing contents of the first portion of the physical hardware by trusted platform module (TPM), or
locking contents of the first portion of the physical hardware by a physical key.

190. The computer-implemented method of claim 188, wherein said storing the virtual appliances and the hypervisor comprises:
storing first data associated with each of the virtual appliances and the hypervisor in the first portion of the physical hardware, the first data comprising at least one of: application binary, operating system (OS) binary, or configuration data.

191. The computer-implemented method of claim 190, further comprising:
storing second data associated with each of the virtual appliances logically or physically separate from the first data, the second data comprising at least one of: application data, run time variables, or user data.

192. The computer-implemented method of claim 191, wherein the second data is stored in a second portion of the physical hardware that is readable and writable.

193. The computer-implemented method of claim 185, further comprising providing the physical hardware to a client associated with the request.

194. The computer-implemented method of claim 193, wherein said providing the physical hardware to the client comprises at least one of:
providing one or more computing devices together with the deployed physical hardware to the client, or
providing an instruction to the client, the instruction indicating the client to connect the physical hardware to one or more computing devices.

195. The computer-implemented method of claim 184, wherein deploying the virtual system image comprises:
deploying the virtual system image onto one or more cloud servers by deploying the virtual appliances in the virtual system image to a hypervisor on the cloud servers.

196. The computer-implemented method of claim 195, wherein said locking down the virtual computing system comprises:
locking down at least one of the virtual appliances or configuration data associated with at least one of the virtual appliances installed on the hypervisor.

197. The computer-implemented method of claim 196, wherein said locking down the virtual computing system comprises at least one of:
configuring at least one of the virtual appliances or the configuration data associated with at least one of the virtual appliances installed on the hypervisor to be read-only,
encrypting at least one of the virtual appliances or the configuration data associated with at least one of the virtual appliances installed on the hypervisor, or
disabling user login to at least one of the virtual appliances.

198. The computer-implemented method of claim 182, further comprising locking down the virtual system image.

199. The computer-implemented method of claim 198, wherein said locking down the virtual system image comprises at least one of:
configuring the virtual system image to be read-only,
encrypting the virtual system image, or
obscuring the virtual system image.

200. A non-transitory computer-readable storage medium coupled to one or more processors and having instructions stored thereon which, when executed by the one or more processors, cause the one or more processors to perform operations, comprising:
receiving a request for one or more computing services;
determining, based on the request, a virtual system image configured to provide a virtual computing system that provides the requested computing services;
deploying the virtual system image; and
locking down the virtual computing system.

201. A system, comprising:
one or more processors; and
a computer-readable storage medium in communication with the one or more processors and having instructions stored thereon which, when executed by the one or more processors, cause the one or more processors to perform operations, comprising:
receiving a request for one or more computing services;
determining, based on the request, a virtual system image configured to provide a virtual computing system that provides the requested computing services;
deploying the virtual system image; and
locking down the virtual computing system.
